(19) United States
(12) Patent Application Publication
(10) Pub. No.: US 2007/0213030 A1
(43) Pub. Date: Sep. 13, 2007

(54) Network support for providing cost notification associated with completed services

(76) Inventors: David S. Benco, Winfield, IL (US); Sanjeev Mahajan, Naperville, IL (US); Baoling S. Sheen, Naperville, IL (US); Sandra Lynn True, St. Charles, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/371,664

(22) Filed: Mar. 9, 2006

(51) Int. Cl. H04M 11/00

(52) U.S. Cl. 455/405

(57) ABSTRACT

Methods are disclosed for determining end user costs incurred for recently completed calls or services and providing timely notice of such costs to the subscriber. Embodiments of the invention provide for cost notification associated with a last completed call/service and cost notification associated with one or more recent calls responsive to a customer query.

### FIELD OF THE INVENTION

This invention relates generally to telecommunication networks and, more particularly, to cost notification features for telecommunication networks.

### BACKGROUND OF THE INVENTION

Communication systems are well known in which persons may obtain various services including, without limitation, voice telephony service, paging, short message service, e-mails, music downloads, video clips, games, ringtones, etc. Depending on the service, the services may be accessed by devices including, without limitation, mobile phones, POTS phones, VoIP phones, pagers, PDAs, PCs, etc. Most typically, service providers use some type of calling/service plan to implement billing for the various services. Multiple services may require separate service plans (possibly with different service providers) or may be integrated into a single service plan. Usually, under such plans, the subscriber pays a monthly fee for a certain service package associated with one or more types of services. Oftentimes, the package provides the subscriber a certain threshold amount of free minutes, downloads, or the like (i.e., included within a “basic” package), depending on the applicable service. Services exceeding the package thresholds are usually charged a per-minute rate or per-use rate, depending on the applicable service. Additional “roaming” charges may also apply if the subscriber roams outside of his or her home service area. As will be appreciated, service providers have great flexibility in how they arrange their service plans and billing and this will continue to evolve as the services evolve and as new services are introduced.

A problem that arises with the introduction of more and more calling plans and call/service types into the marketplace, is that it becomes increasingly difficult for subscribers to determine if their calls/service usages are included within their basic service package(s) or if the call/service is subject to additional fees or roaming charges. A related problem is that subscribers are generally not informed of charges incurred for completed calls/services until they receive their monthly billing statement. Indeed, service providers most typically compute subscriber charges coincident with the end-of-month billing cycle (referred to as “post-processing”) and do not even know subscriber charges incurred on a call by call basis. Consequently, at such time as the billing statement is received, subscribers may be unpleasantly surprised to see unexpected charges appearing on their statement, at least some of which may have been avoided had the subscriber been timely notified of the charges.

### SUMMARY OF THE INVENTION

These problems are addressed and a technical advance is achieved in the art by a feature whereby a network device determines costs for completed calls/services (i.e., sometime prior to the end of month billing cycle) and provides timely notice of the charges incurred to the subscriber. Embodiments of the invention provide for cost notification associated with a last completed call/service and cost notification associated with one or more recent calls responsive to a customer query.

In one embodiment, there is provided a cost notification feature associated with a last completed call/service. Upon implementing the last completed call/service for an end user, a network device identifies a calling/service plan associated with the call/service and end user. Sometime prior to a usual billing cycle associated with the calling/service plan, the network device determines end user costs for the last completed call/service; and sends a cost notification to the end user. Optionally, the cost notification may be inhibited if the end user costs associated with the last completed call/service is at or below a threshold amount (e.g., no notification for zero costs).

In another embodiment, there is provided a cost notification feature associated with recently completed calls/services responsive to a customer query. Upon receiving a customer query, a network device identifies a calling/service plan associated with the recently completed calls/services. Sometime prior to a usual billing cycle associated with the calling/service plan, the network device determines end user costs for the calls/services; and sends a cost notification to the end user.

### BRIEF DESCRIPTION OF THE DRAWINGS

The foregoing and other advantages of the invention will become apparent upon reading the following detailed description and upon reference to the drawings in which:

FIG. 1 is a block diagram of a communication system in which embodiments of the present invention may be implemented;

FIG. 2 is a flowchart of a method for providing cost notification associated with a last completed call/service; and

FIG. 3 is a flowchart of a method for providing cost notification associated with one or more recent calls/services responsive to a customer query.

### DESCRIPTION OF THE PREFERRED EMBODIMENT(S)

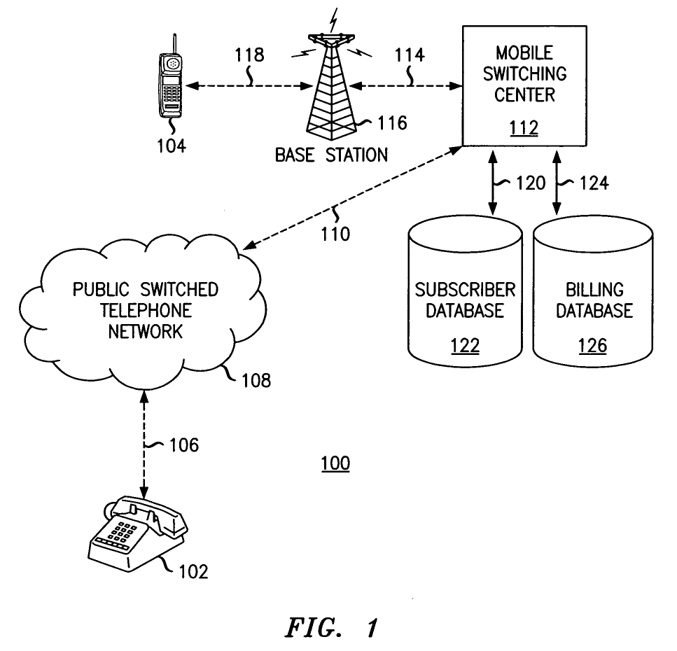

FIG. 1 shows a communication system 100 according to an exemplary embodiment of the invention that supports a cost notification service for recently completed calls/services. Customer calls or services may be initiated or received by mobile phones, POTS phones, VoIP phones, pagers, PDAs, PCs or generally any communication device that is capable of initiating or receiving calls. For convenience, only one each of a wireline device 102 and wireless device 104 is shown. However, as will be appreciated, the communication system 100 is operable to support calls involving virtually any number or combination of wireless and wireline devices.

The wireline device 102 is connected by link 106 to a network 108 (as shown, the Public Switched Telephone Network (PSTN)). The network 108 may be implemented using any appropriate transmission, switching and routing technologies, including but not limited to Internet Protocol (IP) and Asynchronous Transfer Mode (ATM) technologies. The network 108 is connected by link 110 to a switching element 112 (as shown, a mobile switching center (MSC)). The switching element 112 is connected by link 114 to a base station 116, which is connected by wireless link 118 to the wireless device 104. The wireless link 118 may implement air interface technologies including but not limited to, CDMA, TDMA, GSM, UMTS or IEEE 802.11.

The switching element 112 is a call processing control entity that routes calls, as may be appropriate, between calling and called party devices. The switching element 112 is a functional element that may reside in a single switch or may be distributed among multiple switches and/or locations. In the case where the switching element 112 comprises an MSC, the MSC includes home location register (HLR) and visitor location register (VLR) functionality to monitor the location of mobile units as they roam between different cell sites or between different service areas controlled by different MSCs. The MSC may comprise, for example, an AUTOPLEX™ switching system, available from Lucent Technologies, Inc. Alternatively or additionally, the switching element 112 may comprise a central office switch (not shown), such as a 5ESS® switching system, available from Lucent Technologies, Inc. In either case, the switching element 112 includes a memory and processor (not shown), for storing and executing software routines for processing and switching calls and for providing various call features and services to calling or called parties. The switching element 112 may be configured for operation with generally any suitable circuit, cell, or packet switching technology.

As shown, the switching element 112 is further connected by link 120 to a subscriber database 122 and by link 124 to a billing database 126. Links 120, 124 (as well as links 106, 110, 114) are logical links that may be physically realized, without limitation, by conventional subscriber lines, Asynchronous Transfer Mode (ATM) lines, ISDN lines, Ethernet LAN or WAN, wireless links, and the like.

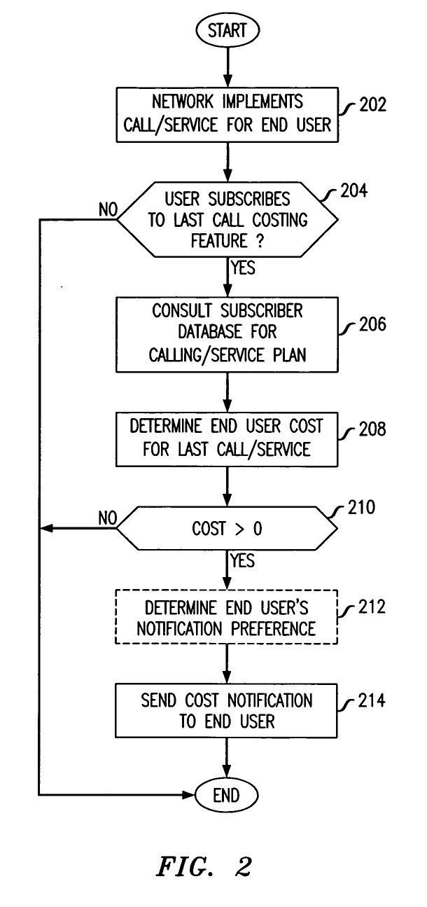

In one embodiment, the subscriber database 122 includes information associated with a plurality of subscribers including, without limitation, directory numbers and calling/service plans of various subscribers. In one embodiment, calling/service plans are indexed by directory number of the subscriber's mobile phone. Depending on the applicable services, calling/service plans may also be indexed by alternate delivery devices. Generally, it is contemplated that the subscriber database will include indicia, for each of a plurality of subscribers, of one or more service packages and one or more applicable delivery devices. To illustrate for purposes of example and without limitation, the subscriber database may indicate service packages associated with: wireless voice minutes, SMS messages, video messages, feature usage charges, download charges for ringtones, wallpapers or games; and delivery devices may include mobile phones, POTS phones, VoIP phones, pagers, PDAs, PCs, etc. In one embodiment, the subscriber database also includes a “flag” or other information indicating whether the subscriber subscribes to a last call costing feature (described in relation to FIG. 2). Depending on implementation, the subscriber database may also include accumulated minutes, services, roaming information, etc.

The billing database 126 includes billing information associated with various calling/service plans. In one embodiment, the billing database includes accumulated billing activity (e.g., minutes, services and roaming information) for various subscribers. For purposes of example and without limitation, in the context of a wireless voice package, the billing database may indicate that a subscriber has accumulated 290 any time minutes and 2000 night and weekend minutes so far this month; or in the context of an SMS message package, the billing statement may indicate that a subscriber has sent 100 outgoing messages and received 200 incoming messages so far this month. In one embodiment, the billing activity is incremented during or immediately succeeding subscriber calls/services. It is noted, although the billing database includes billing activity information, the billing database does not typically include incurred costs. Service providers can derive costs from the billing activity but do not typically do so until the end of the month billing cycle. However, according to embodiments of the present invention, the billing database is consulted and costs derived from the billing activity on a call by call basis or responsive to customer requests (i.e., prior to the end of month billing cycle).

As will be appreciated, the subscriber database 122 and billing database 126 are functional elements that may be implemented in one or more physical databases and may be implemented as a part of the switching system 112 or distributed from the switching system 112. Accordingly, to the extent the preceding or foregoing description refers to data maintained in or retrieved from the subscriber database 122 and billing database 126, such data may be reside in any combination of the subscriber database, billing database 126 or switching system 112 and the same data may reside in multiple databases.

Turning now to FIG. 2, there is shown a flowchart of a method that may be implemented to provide cost notification associated with a last completed customer call or service. The steps of FIG. 2 are implemented using stored software routines within the switching element 112, subscriber database 122 and/or billing database 126.

At step 202, the switching element 112 implements a call or service to an end user/customer. For example, in the context of a call, the switching element connects a call to or from the end user. In the context of a service, the switching element connects the end user to an appropriate server (e.g., SMS message server) necessary to implement the service. The method presumes that coincident to implementing the call/service, the switching element 112 identifies the directory number or other identification number of the end user device and delivers the service to that device. The method further presumes that coincident to implementing the call or service, the switching element and/or the billing database keeps track of billing activity (e.g., minutes, services and roaming information) associated with the call or service.

At step 204, the switching element 112 consults the subscriber database 122 to determine whether the end user subscribes to a last call costing feature. In one embodiment, the presence of the directory number or other identification number of the end user device in the subscriber database in conjunction with a “flag” or other indicia of authorization indicates that the end user subscribes to the last call costing feature. The last call costing feature may be authorized for one or more end user devices and one or more service types. Depending on implementation, the last call costing feature may be included as part of one or more service packages of the end user or may be subscribed to as a separate service (i.e., independent of other service packages). The last call costing feature may be authorized for the entire set of subscribed-to services or a subset. For example, for an end user that subscribes to a voice call package and an SMS package, the last call costing feature could be authorized for voice calls but not for SMS messages.

A negative determination at step 204 indicates that the last call costing feature is not authorized for the just completed call/service. In such case, the process ends without providing cost notification to the end user. Conversely, a positive determination at step 204 indicates that the last call costing feature is authorized for the just completed call/service. If last call costing feature is authorized, the process proceeds to step 206.

At step 206, the switching element l 12 consults the subscriber database 122 to identify the end user calling/service plan, if any, applicable to the just completed call. For example, in the instance where the last completed call is a wireless voice call, the switching element consults the subscriber database to identify the wireless voice package of the subscriber. For example and without limitation, the wireless voice package may indicate a threshold number of any time minutes and night and weekend minutes associated with the package. As another example, in the case where the last completed call/service is an SMS message, the switching element consults the subscriber database to identify the SMS package, if any, of the subscriber.

At step 208, having identified the applicable calling/service plan at step 206, the switching element determines the end user cost for the last completed call/service. In one embodiment, the switching element consults the billing database for relevant end user minutes, service usages, etc. (e.g., accumulated to date) and compares to the relevant data to the calling/service plan thresholds to determine whether and to what extent costs apply to the just completed call. This embodiment presumes the billing database is already updated with activity (but not costs) from the just completed call. Alternatively, in the case where the billing database is not up to date, the switching element may independently add the recent call/service activity to the previously accumulated call/service activity before comparing to the relevant calling/service plan thresholds and determining costs.

At step 210, a decision is made as to whether any end user costs are incurred as a result of the just completed call. Typically, for example, no costs are incurred if the just completed call/service is within the bounds of the relevant calling/service plan; however, costs will be incurred if the call/service is not covered by or exceeds the thresholds of the calling/service plan. The method presumes that cost notification will be desired only if costs are incurred. Hence, if no costs are incurred, the process ends without providing cost notification to the end user. If costs are incurred, the process proceeds to step 212. Alternatively, as will be appreciated, other minimum thresholds (i.e., other than zero) may be established as a basis for providing or inhibiting cost notification. As still another alternative, different thresholds may dictate a manner or degree of notification (e.g., the higher the threshold, the greater degree of urgency of notification). The thresholds may be defined by the user or the service provider.

Optionally, at step 212, the switching element consults the subscriber database to determine the end users notification preference. The notification preference may specify a particular type of notification (e.g., SMS message, voice message, e-mail) and/or a particular delivery device.

At step 214, the switching element sends a cost notification associated with the last completed call/service to the end user. If a notification preference is specified at step 212, the cost notification is delivered as specified by the notification preference. In one embodiment, if no notification preference is specified, the switching element delivers the cost notification by default to the same device associated with the last completed call/service. Thus, for example, in the case where the last completed call is a wireless voice call, the switching element delivers the cost notification to the wireless phone of the subscriber. As will be appreciated, the cost notification may be sent by one or more message types (e.g., SMS message, voice message, e-mail) depending on the characteristics of the delivery device.

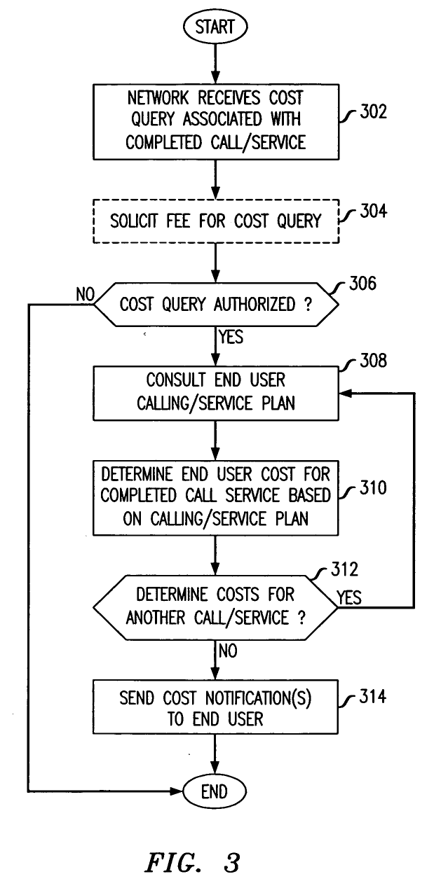

Now referring to FIG. 3, there is shown a flowchart of a method for providing cost notification associated with one or more recent calls/services responsive to a customer query. The steps of FIG. 3 are implemented using stored software routines within the switching element 11 2, subscriber database 122 and/or billing database 126.

At step 302, the switching element 112 receives a cost query associated with one or more recent calls/services. For example, the cost query may request costs associated with calls/services that have been incurred subsequent to the last customer billing cycle. The cost query may be initiated from virtually any communication device or computing device, including but not limited to devices that were not utilized for the previous calls/services. For example and without limitation, a customer may initiate a cost query from a PC to request cost information associated with recent mobile phone usage. The method presumes that coincident to receiving the cost query, the switching element 112 identifies a subscriber or device identification number that will enable it to retrieve billing activity (e.g., minutes, services and roaming information) associated with the recent calls/services. As will be appreciated, the cost query may be implemented by various keys, keystrokes, codes or the like depending on characteristics of the querying device.

Optionally, at step 304, responsive to receiving the cost query, the switching element may solicit a fee for the cost query. For example, if the cost query is not pre-authorized as a part of a service package or independent service, the service provider may charge a per-use fee for the cost query.

At step 306, the switching element 112 determines if the cost query is authorized. As has been noted, the cost query may be pre-authorized as a part of a service package or independent service or may be authorized responsive to the end user paying (or agreeing to pay) a per-use fee for the cost query. If the cost query is not authorized, the process ends without providing cost notification to the end user. If the cost query is authorized, the process proceeds to step 308.

At step 308, the switching element 112 consults the subscriber database 122 to identify the end user calling/service plan, if any, applicable to the just completed call. For example and without limitation, the switching element may consult the subscriber database to identify a wireless voice package or SMS message package of the subscriber such as described in relation to FIG. 2.

At step 310, having identified the applicable calling/service plan at step 308, the switching element determines the end user cost(s) for one or more recently completed calls/services associated with the query. In one embodiment, the switching element consults the billing database for relevant end user minutes, service usages, etc. (e.g., accumulated to date) and compares to the relevant data to the calling/service plan thresholds to determine whether and to what extent costs apply to the recently completed call(s). This embodiment presumes the billing database is already updated with activity (but not costs) from the recently completed call(s). Alternatively, in the case where the billing database is not up to date, the switching element may independently add the recent call/service activity to the previously accumulated call/service activity before comparing to the relevant calling/service plan thresholds and determining costs.

At step 312, the switching element determines if there are costs to be determined in association with any additional calls/services requested in the cost query. If there are additional costs to be determined, the process returns to step 308. If there are no additional costs to be determined, the process proceeds to step 314.

At step 314, the switching element sends a cost notification associated with the last completed call/service to the end user. As will be appreciated, the cost notification may be sent by one or more message types (e.g., SMS message, voice message, e-mail) depending on the delivery device. The delivery device may be determined by default or according to an end user notification preference, such as described in relation to FIG. 2.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In a communication system implementing a call/service for an end user, a method comprising steps of:
identifying a calling/service plan associated with the call/service and end user;
sometime prior to a usual billing cycle associated with the calling/service plan, determining end user costs for the call/service; and
if the end user costs are greater than zero, sending a cost notification to the end user with indicia of the end user costs.

2. The method of claim 1, wherein the call/service comprises one of: voice telephony service, data services, paging, short message service, e-mails, music downloads, pictures, video clips, games and ringtones.

3. The method of claim 1, wherein the call/service comprises a most recent call/service relative to other calls/services thereby defining a last call/service, the steps of determining user costs and notifying the end user being accomplished automatically after completing the last call/service.

4. The method of claim 3, further comprising determining if the end user subscribes to a last call costing feature, the steps of determining user costs and notifying the end user being accomplished only if the end user subscribes to the last call costing feature.

5. The method of claim 1, wherein the step of determining end user costs comprises determining end user billing activity relative to one or more thresholds of the calling/service plan.

6. The method of claim 5, wherein the step of notifying the end user is accomplished if the last call/service causes the end user billing activity to exceed one or more of the thresholds.

7. The method of claim 1, further comprising:
determining a notification preference of the end user; and
if the end user costs are greater than zero, sending a cost notification to the end user according to the notification preference.

8. The method of claim 7, wherein the notification preference specifies a message type, the step of sending a cost notification comprising sending the cost notification according to the specified message type.

9. The method of claim 7, wherein the notification preference specifies a delivery device, the step of sending a cost notification comprising sending the cost notification to the specified delivery device.

10. A method comprising:
receiving a cost query associated with a completed call/service;
identifying a calling/service plan associated with the completed call/service;
sometime prior to a usual billing cycle associated with the calling/service plan, determining end user costs for the call/service; and
sending a cost notification to the end user.

11. The method of claim 10, wherein the cost query is associated with one or more of: voice telephony service, data services, paging, short message service, e-mails, music downloads, pictures, video clips, games and ringtones.

12. The method of claim 10, further comprising determining authorization for the cost query, the steps of determining user costs and notifying the end user being accomplished only if the cost query is authorized.

13. The method of claim 10, wherein the step of determining end user costs comprises determining end user billing activity relative to one or more thresholds of the calling/service plan.

14. The method of claim 13, wherein the step of notifying the end user is accomplished if the completed call/service causes the end user billing activity to exceed one or more of the thresholds.
